(19) United States
(12) Patent Application Publication
(10) Pub. No.: US 2026/0337423 A1
(43) Pub. Date: Oct. 29, 2026

(54) ELECTRODEPOSITABLE COATING COMPOSITIONS

(71) Applicant: PPG Industries Ohio, Inc., Cleveland, OH (US)

(72) Inventors: David Alfred Stone, Allison Park, PA (US); Egle Puodziukynaite, Ridgecrest, CA (US); Ross Anthony Moretti, Pittsburgh, PA (US); Marissa Elizabeth Johnson, Valencia, PA (US)

(73) Assignee: PPG Industries Ohio, Inc., Cleveland, OH (US)

(21) Appl. No.: 19/115,272

(22) PCT Filed: Sep. 22, 2023
(86) PCT No.: PCT/US2023/074867

§ 371 Date: Mar. 26, 2025

Related U.S. Application Data
(60) Provisional application No. 63/377,211, filed on Sep. 27, 2022.

(51) Int. Cl. C09D 5/44; C08G 18/58; C08G 18/62; C09D 175/04

(52) U.S. Cl. CPC C09D 5/4465; C08G 18/58; C08G 18/6212; C09D 175/04

(57) ABSTRACT

The present disclosure is directed to electrodepositable coating compositions comprising (a) a hydroxyl-functionalized branched polymerizate; (b) an ionic salt group-containing film-forming polymer different from the hydroxyl-functionalized branched polymerizate; and (c) a curing agent. Also disclosed are methods of coating a substrate, coatings, and coated substrates.

### FIELD

The present disclosure is directed towards an electrodepositable coating composition, treated substrates and methods of coating substrates.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially. An electrodepositable coating composition that provides crater control and edge coverage is desired.

### SUMMARY

The present disclosure provides an electrodepositable coating composition comprising (a) a hydroxyl-functionalized branched polymerizate; (b) an ionic salt group-containing film-forming polymer different from the hydroxyl-functionalized branched polymerizate; and (c) a curing agent.

The present disclosure also provides a method of coating a substrate comprising electrophoretically applying coating deposited from an electrodepositable coating composition comprising (a) a hydroxyl-functionalized branched polymerizate; (b) an ionic salt group-containing film-forming polymer different from the hydroxyl-functionalized branched polymerizate; and (c) a curing agent, onto at least a portion of the substrate.

The present disclosure further provides a coating deposited from an electrodepositable coating composition comprising (a) a hydroxyl-functionalized branched polymerizate; (b) an ionic salt group-containing film-forming polymer different from the hydroxyl-functionalized branched polymerizate; and (c) a curing agent.

The present disclosure further provides coated substrate having a coating comprising (a) a hydroxyl-functionalized branched polymerizate; (b) an ionic salt group-containing film-forming polymer different from the hydroxyl-functionalized branched polymerizate; and (c) a curing agent.

### DETAILED DESCRIPTION

The present disclosure is directed to an electrodepositable coating composition comprising (a) a hydroxyl-functionalized branched polymerizate; (b) an ionic salt group-containing film-forming polymer different from the hydroxyl-functionalized branched polymerizate; and (c) a curing agent.

According to the present disclosure, the term “electrodepositable coating composition” refers to a composition that is capable of being deposited onto an electrically conductive substrate under the influence of an electrical potential applied between two electrodes immersed in the electrodepositable coating composition, where one of the electrodes is the substrate to be coated.

### Hydroxyl-Functionalized Branched Polymerizate

According to the present disclosure, the electrodepositable coating compositions comprises a hydroxyl-functionalized branched polymerizate.

As used herein, the term “hydroxyl-functionalized branched polymerizate” refers to a polymer having a main carbon-based polymer backbone from which carbon-based sidechains extend, and at least a portion of the carbon-based sidechains include hydroxyl functional groups. The hydroxyl-functionalized branched polymerizate may be obtained by copolymerization of at least one alpha-olefin monomer having at least six carbon atoms per molecule and at least one hydroxyl-functional unsaturated monomer polymerized under conditions effective to promote branching. As used herein, the term “polymerizate” refers to a product (i.e., polymer) of the polymerization of monomers.

The hydroxyl-functionalized branched polymerizate may comprise a branched polyalpha-olefin. The branched polyalpha-olefin may comprise constitutional units comprising the residue of (i) an alpha-olefin monomer having at least 6 carbon atoms; and (ii) a hydroxyl-functional unsaturated monomer.

The alpha-olefin monomer may comprise an ethylenically unsaturated organic compound having at least six carbon atoms and a terminal carbon-carbon bond. The ethylenically unsaturated organic compound may have a structure H₂C═CH—R, wherein R is a hydrocarbon group having at least four carbon atoms, such as at least six carbon atoms, such as at least 10 carbon atoms. The alpha-olefin monomer comprises a C6-C50 alpha-olefin, such as a C6 to C40 alpha-olefin, such as a C6 to C30 alpha-olefin, such as C6 to C20 alpha-olefin. R may be an alkyl group. As used herein, “alkyl” refers to a hydrocarbon chain that may be linear or branched and may comprise one or more hydrocarbon rings that are not aromatic. For example, the alpha-olefin monomer may comprise 1-decene, 1-dodecene, 1-tetradecene, 1-hexadecene, 1-octadecene, 1-eicosene, or any combination thereof, as well as other monomers.

The hydroxyl-functionalized branched polymerizate may comprise constitutional units of the alpha-olefin monomer in an amount of at least 3% by weight, such as at least 5% by weight, such as at least 20% by weight, such as at least 33% by weight, such as at least 40% by weight, such as at least 50% by weight, such as at least 65% by weight, such as at least 80% by weight, such as least 88% by weight, such as at least 90% by weight, based on the total weight of the hydroxyl-functionalized branched polymerizate. The hydroxyl-functionalized branched polymerizate may comprise constitutional units of the alpha-olefin monomer in an amount of no more than 97% by weight, such as no more than 95% by weight, such as no more than 88% by weight, such as no more than 80% by weight, such as no more than 67% by weight, such as no more than 60% by weight, such as no more than 50% by weight, such as no more than 35% by weight, such as no more than 20% by weight, such as no more than 12% by weight, such as no more than 10% by weight, based on the total weight of the hydroxyl-functionalized branched polymerizate. The hydroxyl-functionalized branched polymerizate may comprise constitutional units of the alpha-olefin monomer in an amount of 3% to 97% by weight, such as 3% to 95% by weight, such as 3% to 88% by weight, such as 3% to 80% by weight, such as 3% to 67% by weight, such as 3% to 60% by weight, such as 3% to 50% by weight, such as 3% to 35% by weight, such as 3% to 20% by weight, such as 3% to 12% by weight, such as 3% to 10% by weight, such as 5% to 97% by weight, such as 5% to 95% by weight, such as 5% to 88% by weight, such as 5% to 80% by weight, such as 5% to 67% by weight, such as 5% to 60% by weight, such as 5% to 50% by weight, such as 5% to 35% by weight, such as 5% to 20% by weight, such as 5% to 12% by weight, such as 5% to 10% by weight, such as 20% to 97% by weight, such as 20% to 95% by weight, such as 20% to 88% by weight, such as 20% to 80% by weight, such as 20% to 67% by weight, such as 20% to 60% by weight, such as 20% to 50% by weight, such as 20% to 35% by weight, 33% to 97% by weight, such as 33% to 95% by weight, such as 33% to 88% by weight, such as 33% to 80% by weight, such as 33% to 67% by weight, such as 33% to 60% by weight, such as 33% to 50% by weight, such as 33% to 35% by weight, such as 40% to 97% by weight, such as 40% to 95% by weight, such as 40% to 88% by weight, such as 40% to 80% by weight, such as 40% to 67% by weight, such as 40% to 60% by weight, such as 40% to 50% by weight, such as 50% to 97% by weight, such as 50% to 95% by weight, such as 50% to 88% by weight, such as 50% to 80% by weight, such as 50% to 67% by weight, such as 50% to 60% by weight, such as 65% to 97% by weight, such as 65% to 95% by weight, such as 85% to 88% by weight, such as 65% to 80% by weight, such as 65% to 67% by weight, such as 80% to 97% by weight, such as 80% to 95% by weight, such as 80% to 88% by weight, such as 88% to 97% by weight, such as 88% to 95% by weight, such as 90% to 97% by weight, such as 90% to 95% by weight, based on the total weight of the hydroxyl-functionalized branched polymerizate.

The hydroxyl-functional unsaturated monomer may comprise an alpha, beta-unsaturated alcohol. The hydroxyl-functional unsaturated monomer may comprise, for example, allyl alcohol, 5-hexen-1-ol, 3-hexen-1-ol, 4-penten-1-ol, 3-penten-1-ol, 3-buten-1-ol, crotyl alcohol, elaidyl alcohol (9-trans-octadecen-1-ol), gadoleyl alcohol (9-cis-eicosen-1-ol), 9-decen-1-ol, 9-dodecen-1-ol, 10-undecylenyl alcohol, oleyl alcohol (9-cis-octadecen-1-ol), erucyl alcohol (13-cis-docosen-1-ol), brassidyl alcohol (13-trans-docosen-1-ol), ethoxylated and/or propoxylated derivatives thereof, acetic acid and formic acid esters of these alcohols, or any combination thereof, as well as other monomers.

The hydroxyl-functionalized branched polymerizate may comprise constitutional units of the hydroxyl-functional unsaturated monomer in an amount of at least 3% by weight, such as at least 5% by weight, such as at least 20% by weight, such as at least 33% by weight, such as at least 40% by weight, such as at least 50% by weight, such as at least 65% by weight, such as at least 80% by weight, such as least 88% by weight, such as at least 90% by weight, based on the total weight of the hydroxyl-functionalized branched polymerizate. The hydroxyl-functionalized branched polymerizate may comprise constitutional units of the hydroxyl-functional unsaturated monomer in an amount of no more than 97% by weight, such as no more than 95% by weight, such as no more than 88% by weight, such as no more than 80% by weight, such as no more than 67% by weight, such as no more than 60% by weight, such as no more than 50% by weight, such as no more than 35% by weight, such as no more than 20% by weight, such as no more than 12% by weight, such as no more than 10% by weight, based on the total weight of the hydroxyl-functionalized branched polymerizate. The hydroxyl-functionalized branched polymerizate may comprise constitutional units of the hydroxyl-functional unsaturated monomer in an amount of 3% to 97% by weight, such as 3% to 95% by weight, such as 3% to 88% by weight, such as 3% to 80% by weight, such as 3% to 67% by weight, such as 3% to 60% by weight, such as 3% to 50% by weight, such as 3% to 35% by weight, such as 3% to 20% by weight, such as 3% to 12% by weight, such as 3% to 10% by weight, such as 5% to 97% by weight, such as 5% to 95% by weight, such as 5% to 88% by weight, such as 5% to 80% by weight, such as 5% to 67% by weight, such as 5% to 60% by weight, such as 5% to 50% by weight, such as 5% to 35% by weight, such as 5% to 20% by weight, such as 5% to 12% by weight, such as 5% to 10% by weight, such as 20% to 97% by weight, such as 20% to 95% by weight, such as 20% to 88% by weight, such as 20% to 80% by weight, such as 20% to 67% by weight, such as 20% to 60% by weight, such as 20% to 50% by weight, such as 20% to 35% by weight, 33% to 97% by weight, such as 33% to 95% by weight, such as 33% to 88% by weight, such as 33% to 80% by weight, such as 33% to 67% by weight, such as 33% to 60% by weight, such as 33% to 50% by weight, such as 33% to 35% by weight, such as 40% to 97% by weight, such as 40% to 95% by weight, such as 40% to 88% by weight, such as 40% to 80% by weight, such as 40% to 67% by weight, such as 40% to 60% by weight, such as 40% to 50% by weight, such as 50% to 97% by weight, such as 50% to 95% by weight, such as 50% to 88% by weight, such as 50% to 80% by weight, such as 50% to 67% by weight, such as 50% to 60% by weight, such as 65% to 97% by weight, such as 65% to 95% by weight, such as 85% to 88% by weight, such as 65% to 80% by weight, such as 65% to 67% by weight, such as 80% to 97% by weight, such as 80% to 95% by weight, such as 80% to 88% by weight, such as 88% to 97% by weight, such as 88% to 95% by weight, such as 90% to 97% by weight, such as 90% to 95% by weight, based on the total weight of the hydroxyl-functionalized branched polymerizate.

The molar ratio of alpha-olefin monomer to the hydroxyl-functional unsaturated monomer may be from 20:1 to 1:20, or from 10:1 to 1:10, or from 8:1 to 1:2.

The polymerization product may be obtained, for example, by subjecting a mixture of the alpha-olefin monomer, the hydroxyl-functional unsaturated monomer, and at least one polymerization initiator to reaction conditions sufficient to copolymerize the alpha-olefin monomer and the hydroxyl-functional unsaturated monomer. The reaction conditions are not limited so long as the monomers can react to form the polymerization product, and non-limiting exemplary processes are described below.

The polymerization product may be prepared via polymerization of an ethylenically unsaturated polymerizable monomer composition in a dispersing medium comprising water by techniques well known in the art. For example, the monomer composition may be dissolved or dispersed in water and subjected to addition polymerization conditions by heating in the presence of a free radical initiator. The monomer composition may optionally comprise a surfactant to assist in dispersing the monomer composition, and the surfactant may be a reactive surfactant or an unreactive surfactant. Alternatively, the monomer composition may be substantially free, essentially free, or completely free of reactive and/or unreactive surfactant. The time and temperature of polymerization will depend on one another, the ingredients selected and, in some cases, the scale of the reaction. The polymerization may be conducted at, for example, 40 °C to 100 °C for 2 to 20 hours.

The free radical initiator utilized for the polymerization may be selected from any of those used for aqueous latex polymerization techniques, including redox pair initiators, an organic peroxide, peroxides, hydroperoxides, peroxydicarbonates, azo compounds and the like.

Alternatively, the polymerization product may be prepared in an organic solution by techniques well known in the art. For example, the polymerization product may be prepared by conventional free radical initiated solution polymerization techniques wherein an ethylenically unsaturated monomer composition is dissolved in a solvent or a mixture of solvents and polymerized in the presence of a free radical initiator to form the polymerization product comprising constitutional units comprising the residue of the unsaturated monomers. Examples of suitable solvents which may be used for organic solution polymerization include alcohols, such as ethanol, tertiary butanol, and tertiary amyl alcohol; ketones, such as acetone, methyl ethyl ketone; and ethers, such as dimethyl ether of ethylene glycol. Examples of suitable free radical initiators include those which are soluble in the mixture of monomers, such as azobisisobutyronitrile, 2,2′-azobis(2-methylbutyronitrile), azobis-(alpha, gamma-dimethylvaleronitrile), tertiary-butyl perbenzoate, tertiary-butyl peracetate, benzoyl peroxide, and ditertiary-butyl peroxide. The free radical initiator may be present in an amount of 0.01% to 6% by weight, such as 1.0% to 4.0% by weight, such as 2.0% to 3.5% by weight, based on the total weight of the polymerization product or monomer composition. In examples, the solvent may be first heated to reflux and a mixture of the ethylenically unsaturated monomer composition and a free radical initiator may be added slowly to the refluxing solvent. The reaction mixture may be held at polymerizing temperatures so as to reduce the free monomer content to below 1.0%, such as below 0.5% by weight, based on the total weight of the ethylenically unsaturated monomer composition. The time and temperature of polymerization may depend on one another, the ingredients selected and, in some cases, the scale of the reaction. For example, the polymerization may be conducted at 40 °C to 100 °C for 2 to 20 hours.

The hydroxyl-functionalized branched polymerizate may have a hydroxyl equivalent weight of at least 50 g/eq, such as at least 75 g/eq, such as at least 100 g/eq, such as at least 125 g/eq, such as at least 140 g/eq. The hydroxyl-functionalized branched polymerizate may have a hydroxyl equivalent weight of no more than 3,000 g/eq, such as no more than 1,500 g/eq, such as no more than 750 g/eq, such as no more than 500 g/eq, such as no more than 250 g/eq, such as no more than 150 g/eq. The hydroxyl-functionalized branched polymerizate may have a hydroxyl equivalent weight of 50 to 3,000 g/eq, such as 50 to 1,500 g/eq, such as 50 to 750 g/eq, such as 50 to 500 g/eq, such as 50 to 250 g/eq, such as 50 to 150 g/eq, such as 75 to 3,000 g/eq, such as 75 to 1,500 g/eq, such as 75 to 750 g/eq, such as 75 to 500 g/eq, such as 75 to 250 g/eq, such as 75 to 150 g/eq, such as 100 to 3,000 g/eq, such as 100 to 1,500 g/eq, such as 100 to 750 g/eq, such as 100 to 500 g/eq, such as 100 to 250 g/eq, such as 100 to 150 g/eq, such as 125 to 3,000 g/eq, such as 125 to 1,500 g/eq, such as 125 to 750 g/eq, such as 125 to 500 g/eq, such as 125 to 250 g/eq, such as 125 to 150 g/eq, such as 140 to 3,000 g/eq, such as 140 to 1,500 g/eq, such as 140 to 750 g/eq, such as 140 to 500 g/eq, such as 140 to 250 g/eq, such as 140 to 150 g/eq. As used herein, with respect to the hydroxyl-functionalized branched polymerizate, the “hydroxyl equivalent weight” is a theoretical number determined by dividing the molecular weight of the hydroxyl-functionalized branched polymerizate by the number of hydroxyl groups present in the hydroxyl-functionalized branched polymerizate.

The hydroxyl-functionalized branched polymerizate may have a number average molecular weight of at least 500 g/mol, such as at least 1,000 g/mol, such as at least 1,500 g/mol, such as at least 1,800 g/mol. The hydroxyl-functionalized branched polymerizate may have a number average molecular weight of no more than 10,000 g/mol, such as no more than 5,000 g/mol, such as no more than 3,000 g/mol, such as no more than 2,200 g/mol. The hydroxyl-functionalized branched polymerizate may have a number average molecular weight of 500 to 10,000 g/mol, such as 500 to 5,000 g/mol, such as 500 to 3,000 g/mol, such as 500 to 2,200 g/mol, such as 1,000 to 10,000 g/mol, such as 1,000 to 5,000 g/mol, such as 1,000 to 3,000 g/mol, such as 1,000 to 2,200 g/mol, such as 1,500 to 10,000 g/mol, such as 1,500 to 5,000 g/mol, such as 1,500 to 3,000 g/mol, such as 1,500 to 2,200 g/mol, such as 1,800 to 10,000 g/mol, such as 1,800 to 5,000 g/mol, such as 1,800 to 3,000 g/mol, such as 1,800 to 2,200 g/mol, as determined by Gel Permeation Chromatography using polystyrene calibration standards.

As used herein, unless otherwise stated, the term “number average molecular weight (Mₙ)” means the number average molecular weight (Mₙ) as determined by Gel Permeation Chromatography using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

The hydroxyl-functionalized branched polymerizate may have a z-average molecular weight of at least 4,000 g/mol, such as at least 6,000 g/mol, such as at least 8,500 g/mol. The hydroxyl-functionalized branched polymerizate may have a z-average molecular weight of no more than 15,000 g/mol, such as no more than 12,000 g/mol, such as no more than 9,000 g/mol. The hydroxyl-functionalized branched polymerizate may have a z-average molecular weight of 4,000 to 15,000 g/mol, such as 4,000 to 12,000 g/mol, such as 4,000 to 9,000 g/mol, such as 6,000 to 15,000 g/mol, such as 6,000 to 12,000 g/mol, such as 6,000 to 9.000 g/mol, such as 8,500 to 15,000 g/mol, such as 8,500 to 12,000 g/mol, such as 8,500 to 9,000 g/mol, as determined by Gel Permeation Chromatography using polystyrene calibration standards.

As used herein, unless otherwise stated, the term “z-average molecular weight (M_{z})” means the z-average molecular weight (M_{z}) as determined by Gel Permeation Chromatography using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

The hydroxyl-functionalized branched polymerizate may be present as a reaction product of the hydroxyl-functionalized branched polymerizate and a polyisocyanate. For example, the hydroxyl-functionalized branched polymerizate may be chain extended by reaction with a polyisocyanate wherein the hydroxyl functional groups from the hydroxyl-functionalized branched polymerizate are in molar excess relative to the isocyanato functional groups of the polyisocyanate.

The polyisocyanate may comprise at least 2% by weight of the reaction product, such as at least 5% by weight, such as at least 10% by weight, and the balance may comprise the hydroxyl-functionalized branched polymerizate, for example, at least 80% by weight, such as at least 90% by weight, such as at least 95% by weight, such as at least 98% by weight, based on the total weight of the reaction product.

The ratio of hydroxyl functional groups from the hydroxyl-functionalized branched polymerizate to isocyanato groups from the polyisocyanate may be at least 2.45:1, such as at least 4.9:1.

The hydroxyl-functionalized branched polymerizate may be present as a blocking agent for a polyisocyanate curing agent.

The hydroxyl-functionalized branched polymerizate described above may be present in the electrodepositable coating composition in an amount of at least 0.01% by weight, such as at least 0.1% by weight, such as at least 0.2% by weight, such as at least 0.4% by weight, such as at least 0.5% by weight, such as at least 1% by weight, based on the total weight of the resin solids of the electrodepositable coating composition. The hydroxyl-functionalized branched polymerizate may be present in the electrodepositable coating composition in an amount of no more than 10% by weight, such as no more than 3% by weight, such as no more than 2% by weight, such as no more than 1% by weight, such as no more than 0.85% by weight, based on the total weight of the resin solids of the electrodepositable coating composition. The hydroxyl-functionalized branched polymerizate may be present in the electrodepositable coating composition in an amount of 0.01% to 10% by weight, such as 0.1% to 10% by weight, such as 0.2% to 10% by weight, such as 0.4% to 10% by weight, such as 0.5% to 10% by weight, such as 1% to 10% by weight, such as 0.05% to 3% by weight, such as 0.1% to 3% by weight, such as 0.2% to 3% by weight, such as 0.4% to 3% by weight, such as 0.5% to 3% by weight, such as 1% to 3% by weight, such as 0.01% to 2% by weight, such as 0.1% to 2% by weight, such as 0.2% to 2% by weight, such as 0.4% to 2% by weight, such as 0.5% to 2% by weight, such as 1% to 2% by weight, 0.01% to 1% by weight, such as 0.1% to 1% by weight, such as 0.2% to 1% by weight, such as 0.4% to 1% by weight, such as 0.5% to 1% by weight, 0.01% to 0.85% by weight, such as 0.1% to 0.85% by weight, such as 0.2% to 0.85% by weight, such as 0.4% to 0.85% by weight, such as 0.5% to 0.85% by weight, based on the total weight of the resin solids of the electrodepositable coating composition.

It has been surprisingly discovered that the use of the hydroxyl-functionalized branched polymerizate in an electrodepositable coating composition in the amounts taught herein results in a deposited coating having improved crater resistance.

The presence of the hydroxyl-functionalized branched polymerizate in the amounts disclosed herein in an electrodepositable coating composition may result in a reduction in the depth of craters formed in the cured coating during the curing of the electrodepositable coating composition compared to a substrate coated with a comparative electrodepositable coating composition that does not include the hydroxyl-functionalized branched polymerizate but otherwise has the same composition as the electrodepositable coating composition. For example, the crater depth of the coating on the substrate may be reduced by at least 10% compared to a comparative electrodepositable coating composition having the same composition as the electrodepositable coating composition with the exception that it does not comprise the addition polymer, such as at least 20%, such as at least 30%, such as at least 40%, such as at least 50%, such as at least 55%, such as at least 60%, as measured by the Crater Resistance Test Method. The crater depth of the coating on the substrate may be 15 microns or less, such as 12 microns or less, such as 10 microns, or less, such as 9 microns or less, such as 8 microns or less, as measured by the CRATER DEPTH TEST METHOD. The CRATER DEPTH TEST METHOD is defined in the Examples section below.

### Ionic Salt Group-Containing Film-Forming Polymer

According to the present disclosure, the electrodepositable coating composition may further comprise an ionic salt group-containing film-forming polymer. The ionic salt group-containing film-forming polymer is different from the hydroxyl-functionalized branched polymerizate described above.

According to the present disclosure, the ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; U.S. Pat. No. 3,975,346 at col. 1, line 62 to col. 17, line 25 and U.S. Pat. No. 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Pat. Application No. 12463B 1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Publication No. 2003/0054193 A1 at paragraphs [0096] to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

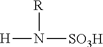

wherein R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ?0.1% based on the total amines in the active hydrogen-containing, cationic salt group-containing film-forming polymer. Alternatively, the amount of acid used to neutralize the active hydrogen-containing, cationic salt group-containing film-forming polymer may be 100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

According to the present disclosure, the cationic salt group-containing film-forming polymer may be present in the cationic electrodepositable coating composition in an amount of at least 40% by weight, such as at least 50% by weight, such as at least 60% by weight, and may be present in the in an amount of no more than 89.99% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 89.99% by weight, such as 50% to 80% by weight, such as 60% to 75% by weight, based on the total weight of the resin solids of the electrodepositable coating composition. As used herein, the “resin solids” include the ionic salt group-containing film-forming polymer, the curing agent, the hydroxyl-functionalized branched polymerizate, and any additional water-dispersible non-pigmented component(s) present in the electrodepositable coating composition.

According to the present disclosure, the ionic salt group containing film-forming polymer may comprise an anionic salt group containing film-forming polymer. As used herein, the term “anionic salt group containing film-forming polymer” refers to an anionic polymer comprising at least partially neutralized anionic functional groups, such as carboxylic acid and phosphoric acid groups that impart a negative charge. As used herein, the term “polymer” encompasses, but is not limited to, oligomers and both homopolymers and copolymers. The anionic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338 at col. 2, line 66 through col. 7, line 26, the cited portion of which is incorporated herein by reference.

According to the present disclosure, the anionic salt group-containing film-forming polymer may be present in the anionic electrodepositable coating composition in an amount of at least 50% by weight, such as at least 55% by weight, such as at least 60% by weight, and may be present in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition.

### Curing Agent

According to the present disclosure, the electrodepositable coating composition of the present disclosure may further comprise a curing agent. The curing agent may be reactive with the hydroxyl-functionalized branched polymerizate and the ionic salt group-containing film-forming polymer. The curing agent may react with the reactive groups, such as active hydrogen groups, of the ionic salt group-containing film-forming polymer and the hydroxyl-functionalized branched polymerizate to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the reaction of the reactive functional groups of the components of the electrodepositable coating composition, and resulting in the crosslinking of the components of the composition and formation of an at least partially cured coating. Non-limiting examples of suitable curing agents are at least partially blocked polyisocyanates, aminoplast resins and phenoplast resins, such as phenolformaldehyde condensates including allyl ether derivatives thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1 line 57 to col. 3 line 15, this portion of which is incorporated herein by reference, or partially blocked aliphatic polyisocyanates that are reacted with the polymer backbone, such as is described in U.S. Pat. No. 3,947,338 at col. 2 line 65 to col. 4 line 30, this portion of which is also incorporated herein by reference. By “blocked” is meant that the isocyanate groups have been reacted with a compound such that the resultant blocked isocyanate group is stable to active hydrogens at ambient temperature but reactive with active hydrogens in the film forming polymer at elevated temperatures, such as between 90 °C and 200 °C. The polyisocyanate curing agent may be a fully blocked polyisocyanate with substantially no free isocyanate groups.

The polyisocyanate curing agent may comprise a diisocyanate, higher functional polyisocyanates or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexmethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

The polyisocyanate curing agent may be at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example dibutylamine; and mixtures thereof. The polyisocyanate curing agent may be at least partially blocked with at least one 1,2-alkane diol having three or more carbon atoms, for example 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime.

The curing agent may comprise an aminoplast resin. Aminoplast resins are condensation products of an aldehyde with an amino- or amido-group carrying substance. Condensation products obtained from the reaction of alcohols and an aldehyde with melamine, urea or benzoguanamine may be used. However, condensation products of other amines and amides may also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol and others, as well as benzyl alcohol and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Aminoplast and phenoplast resins, as described above, are described in U.S. Pat. No. 4,812,215 at col. 6, line 20 to col. 7, line 12, the cited portion of which being incorporated herein by reference.

The curing agent may be present in the cationic electrodepositable coating composition in an amount of at least 10% by weight, such as at least 20% by weight, such as at least 25% by weight and may be present in an amount of no more than 60% by weight, such as no more than 59.95% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 10% to 59.95% by weight, such as 20% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, and may be present in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

### Further Components of the Electrodepositable Coating Compositions

The electrodepositable coating composition according to the present disclosure may optionally comprise one or more further components in addition to the hydroxyl-functionalized branched polymerizate, the ionic salt group-containing film-forming polymer and the curing agent described above.

According to the present disclosure, the electrodepositable coating composition may optionally comprise a catalyst to catalyze the reaction between the curing agent and the polymers. Examples of catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium, zirconium and bismuth) and salts thereof (e.g., bismuth sulfamate and bismuth lactate); or a cyclic guanidine as described in U.S. Pat. No. 7,842,762 at col. 1, line 53 to col. 4, line 18 and col. 16, line 62 to col. 19, line 8, the cited portions of which being incorporated herein by reference. Examples of catalysts suitable for anionic electrodepositable coating compositions include latent acid catalysts, specific examples of which are identified in WO 2007/118024 at par. [0031], the cited portion of which is incorporated herein by reference, and include, but are not limited to, ammonium hexafluoroantimonate, quaternary salts of SbF₆ (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

According to the present disclosure, the electrodepositable coating compositions of the present disclosure may optionally comprise crater control additives which may be incorporated into the coating composition, such as, for example, a polyalkylene oxide polymer which may comprise a copolymer of butylene oxide and propylene oxide. According to the present disclosure, the molar ratio of butylene oxide to propylene oxide in the monomer mixture used to make the polyalkylene oxide polymer and in the resulting polyalkylene oxide polymer may be at least 1:1, such as at least 3:1, such as at least 5:1, and in some instances, may be no more than 50:1, such as no more than 30:1, such as no more than 20:1. According to the present disclosure, the molar ratio of butylene oxide to propylene oxide in the monomer mixture used to make the polyalkylene oxide polymer and in the resulting polyalkylene oxide polymer may be 1:1 to 50:1, such as 3:1 to 30:1, such as 5:1 to 20:1.

The polyalkylene oxide polymer may comprise at least two hydroxyl functional groups, and may be difunctional, trifunctional, or tetrafunctional. As used herein, a “hydroxyl functional group” comprises an —OH group. For clarity, the polyalkylene oxide polymer may comprise additional functional groups in addition to the hydroxyl functional group(s). As used herein, “monofunctional,” when used with respect to the number of hydroxyl functional groups a particular monomer or polymer comprises, means a monomer or polymer comprising one (1) hydroxyl functional group per molecule. As used herein, “difunctional,” when used with respect to the number of hydroxyl functional groups a particular monomer or polymer comprises, means a monomer or polymer comprising two (2) hydroxyl functional groups per molecule. As used herein, “trifunctional,” when used with respect to the number of hydroxyl functional groups a particular monomer or polymer comprises, means a monomer or polymer comprising three (3) hydroxyl functional groups per molecule. As used herein, “tetrafunctional,” when used with respect to the number of hydroxyl functional groups a particular monomer or polymer comprises, means a monomer or polymer comprising four (4) hydroxyl functional groups per molecule.

The hydroxyl equivalent weight of the polyalkylene oxide polymer may be at least 100 g/mol, such as at least 200 g/mol, such as at least 400 g/mol, and may be no more than 2,000 g/mol, such as no more than 1,000 g/mol, such as no more than 800 g/mol. The hydroxyl equivalent weight of the polyalkylene oxide polymer may be 100 g/mol to 2,000 g/mol, such as 200 g/mol to 1,000 g/mol, such as 400 g/mol to 800 g/mol. As used herein, with respect to the polyalkylene oxide polymer, the “hydroxyl equivalent weight” is determined by dividing the molecular weight of the polyalkylene oxide polymer by the number of hydroxyl groups present in the polyalkylene oxide polymer.

The polyalkylene oxide polymer may have a z-average molecular weight (M_{z}) of at least 200 g/mol, such as at least 400 g/mol, such as at least 600 g/mol, and may be no more than 5,000 g/mol, such as no more than 3,000 g/mol, such as no more than 2,000 g/mol. According to the present disclosure, the polyalkylene oxide polymer may have a z-average molecular weight of 200 g/mol to 5,000 g/mol, such as 400 g/mol to 3,000 g/mol, such as 600 g/mol to 2,000 g/mol. As used herein, with respect to polyalkylene oxide polymers having a z-average molecular weight (M_{z}) of less than 900,000, the term “z-average molecular weight (M_{z})” means the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, tetrahydrofuran (THF) with 0.05 M lithium bromide (LiBr) as the eluent at a flow rate of 0.5 mL/min, and one Asahipak GF-510 HQ column for separation.

The polyalkylene oxide polymer may be present in the electrodepositable coating composition in an amount of at least 0.1% by weight based on the total weight of the resin blend solids, such as at least 0.5% by weight, such as at least 0.75% by weight, and in some instances, may be present in the electrodepositable coating composition in an amount of no more than 10% by weight based on the total weight of the resin blend solids, such as no more than 4% by weight, such as no more than 3% by weight. The polyalkylene oxide polymer may be present in the electrodepositable coating composition in an amount of at 0.1% by weight to 10% by weight based on the total weight of the resin blend solids, such as 0.5% by weight to 4% by weight, such as 0.75% by weight to 3% by weight.

According to the present disclosure, the electrodepositable coating composition may comprise other optional ingredients, such as a pigment composition and, if desired, various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The pigment composition may comprise, for example, iron oxides, lead oxides, strontium chromate, carbon black, coal dust, titanium dioxide, talc, barium sulfate, as well as color pigments such as cadmium yellow, cadmium red, chromium yellow and the like. The pigment content of the dispersion may be expressed as the pigment-to-resin weight ratio and may be within the range of 0.03 to 0.6, when pigment is used. The other additives mentioned above may each independently be present in the electrodepositable coating composition in amounts of 0.01% to 3% by weight, based on total weight of the resin solids of the electrodepositable coating composition.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110 °C for 15 minutes.

### Substrates

According to the present disclosure, the electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, each of which arc incorporated herein by reference, or a zirconium containing pretreatment solution such as, for example, those described in U.S. Pat. Nos. 7,749,368 and 8,673,091, each of which are incorporated herein by reference.

### Methods of Coating, Coatings and Coated Substrates

The present disclosure is also directed to methods for coating a substrate, such as any one of the electroconductive substrates mentioned above. The method may comprise electrophoretically applying an electrodepositable coating composition as described above to at least a portion of the substrate and curing the coating composition to form an at least partially cured coating on the substrate. The method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. The method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the top coat.

The cationic electrodepositable coating composition may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250 °F to 450 °F (121.1 °C to 232.2 °C), such as from 275 °F to 400 °F (135 °C to 204.4 °C), such as from 300 °F to 360 °F (149 °C to 180 °C). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

The anionic electrodepositable coating composition may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200 °F to 450 °F (93 °C to 232.2 °C), such as from 275 °F to 400 °F (135 °C to 204.4 °C), such as from 300 °F to 360 °F (149 °C to 180 °C). The curing time may be dependent upon the curing temperature as well as other variables, for example, film thickness of the electrodeposited coating, level and type of catalyst present in the composition and the like. For purposes of the present disclosure, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present disclosure is further directed to a coating formed by at least partially curing the electrodepositable coating composition described herein.

The present disclosure is further directed to a substrate that is coated, at least in part, with the electrodepositable coating composition described herein in an at least partially cured state.

### Multi-Layer Coating Composites

The electrodepositable coating compositions of the present disclosure may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the aqueous resinous dispersion of the present disclosure, and suitable topcoat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, the primer layer is disposed between the electrocoating layer and the base coat layer. According to the present disclosure, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the top-coat layers may be applied directly onto the electrodepositable coating layer. In other words, the substrate lacks a primer layer. For example, a basecoat layer may be applied directly onto at least a portion of the electrodepositable coating layer.

It will also be understood that the top-coat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the top-coat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of the multi-layer composite in any amount sufficient to impart the desired property, visual and/or color effect.

The electrodepositable coating composition of the present disclosure may be substantially free, essentially free, or completely free of silicon dioxide microspheres and/or silicon dioxide nanospheres. As used herein, the electrodepositable coating composition is “substantially free” of silicon dioxide microspheres and/or silicon dioxide nanospheres if the silicon dioxide microspheres and/or silicon dioxide nanospheres are present in the electrodepositable coating composition, if at all, in an amount of less than 3% by weight, based on the total weight of the resin solids. As used herein, the electrodepositable coating composition is “essentially free” of silicon dioxide microspheres and/or silicon dioxide nanospheres if the silicon dioxide microspheres and/or silicon dioxide nanospheres are present in the electrodepositable coating composition, if at all, in an amount of less than 1% by weight, based on the total weight of the electrodepositable coating composition. As used herein, the electrodepositable coating composition is “completely free” of the silicon dioxide microspheres and/or silicon dioxide nanospheres if the silicon dioxide microspheres and/or silicon dioxide nanospheres are not present in the electrodepositable coating composition, i.e., 0% by weight.

As used herein, unless otherwise defined, the term “substantially free” means that the component is present, if at all, in an amount of less than 5% by weight, based on the total weight of the slurry composition.

As used herein, unless otherwise defined, the term “essentially free” means that the component is present, if at all, in an amount of less than 1% by weight, based on the total weight of the slurry composition.

As used herein, unless otherwise defined, the term “completely free” means that the component is not present in the slurry composition, i.e., 0.00% by weight, based on the total weight of the slurry composition.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

In this application, the use of the singular includes the plural and plural encompasses singular, unless specifically stated otherwise. For example, although reference is made herein to “an” hydroxyl-functionalized branched polymerizate, “an” ionic salt group-containing film-forming polymer different from the hydroxyl-functionalized branched polymerizate, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1: Preparation of a Blocked Polyisocyanate Crosslinker for Electrodepositable Coating Compositions (Crosslinker I)

A blocked polyisocyanate crosslinker (Crosslinker I), suitable for use in electrodepositable coating resins, was prepared in the following manner. Components 2-5 listed in Table 1, below, were mixed in a flask set up for total reflux with stirring under nitrogen. The mixture was heated to a temperature of 35 °C, and Component 1 was added dropwise so that the temperature increased due to the reaction exotherm and was maintained under 100 °C. After the addition of Component 1 was complete, a temperature of 110 °C was established in the reaction mixture and the reaction mixture held at temperature until no residual isocyanate was detected by IR spectroscopy. Component 6 was then added, and the reaction mixture was allowed to stir for 30 minutes and cooled to ambient temperature.

TABLE 1

| | | Parts-by- |
|---|---|---|
| No. | Component | weight (grams) |
| 1 | Polymeric methylene diphenyl diisocyanate ¹ | 1340.00 |
| 2 | Dibutyltin dilaurate | 2.61 |
| 3 | Methyl isobutyl ketone | 234.29 |
| 4 | Diethylene glycol monobutyl ether | 324.46 |
| 5 | Ethylene glycol monobutyl ether | 945.44 |
| 6 | Methyl isobutyl ketone | 88.60 |

¹ Rubinate M, available from Huntsman Corporation.

### Example 2: Preparation of a Cationic, Amine-Functionalized, Polyepoxide-Based Resin Without Additives (Comparative Resin Dispersion A)

A cationic, amine-functionalized, polyepoxide-based polymeric resin, suitable for use in formulating electrodepositable coating compositions, was prepared in the following manner. Components 1-5 listed in Table 2, below, were mixed in a flask set up for total reflux with stirring under nitrogen. The mixture was heated to a temperature of 130 °C and allowed to exotherm (175 °C maximum). A temperature of 145 °C was established in the reaction mixture and the reaction mixture was then held for 2 hours. Component 6 was introduced while allowing the mixture to cool to 125 °C followed by the addition of Components 7 and 8. Components 9 and 10 were then added to the reaction mixture quickly and the reaction mixture was allowed to exotherm. A temperature of 122 °C was established and the reaction mixture held for 1 hour, resulting in Resin Synthesis Product A.

TABLE 2

| | | |
|---|---|---|
| | | Parts-by- |
| No. | Component | weight (grams) |

Resin Synthesis Stage

| | | |
|---|---|---|
| 1 | Bisphenol A diglycidyl ether ¹ | 583.94 |
| 2 | Bisphenol A | 252.15 |
| 3 | Bisphenol A - ethylene oxide adduct | 118.75 |
| | (1/6 molar ratio BPA/EtO) | |
| 4 | Methyl isobutyl ketone (MIBK) | 29.53 |
| 5 | Ethyl triphenyl phosphonium iodide | 0.57 |
| 6 | Bisphenol A - ethylene oxide adduct | 118.75 |
| | (1/6 molar ratio BPA/EtO) | |
| 7 | Methyl isobutyl ketone | 116.25 |
| 8 | Crosslinker I ² | 683.69 |
| 9 | Diethylene triamine - MIBK diketimine ³ | 54.16 |
| 10 | Methyl ethanol amine | 46.24 |

Resin Dispersion Stage

| | | |
|---|---|---|
| 11 | Resin Synthesis Product A | 1803.63 |
| 12 | Sulfamic acid | 38.50 |
| 13 | Deionized water | 1093.72 |
| 14 | Gum rosin solution in butyl carbitol formal | 15.69 |
| | (30 wt %) | |
| 15 | Deionized water | 1320.42 |
| 16 | Deionized water | 1100.00 |

¹ EPON 828, available from Hexion Corporation.
² See Example 1, above.
³ 72.7% by weight (in MIBK) of the diketimine reaction product of 1 equivalent of diethylene triamine and 2 equivalents of MIBK.

A portion of the Resin Synthesis Product A (Component 11) was then poured into a pre-mixed solution of Components 12 and 13 to form a resin dispersion. Component 14 was then added quickly, and the resin dispersion was stirred for 1 hour. Component 15 was then introduced over 30 minutes to further dilute the resin dispersion, followed by the addition of Component 16. The free MIBK in the resin dispersion was removed from the dispersion under vacuum at a temperature of 60-70 °C.

The solids content of the resulting cationic, amine-functionalized, polyepoxide-based polymeric resin dispersion (Comparative Resin Dispersion A) was determined by adding a quantity of the resin dispersion to a tared aluminum dish, recording the initial weight of the resin dispersion, heating the resin dispersion in the dish for 60 minutes at 110 °C in an oven, allowing the dish to cool to ambient temperature, reweighing the dish to determine the amount of non-volatile content remaining, and calculating the solids content by dividing the weight of the remaining non-volatile content by the initial resin dispersion weight and multiplying by 100. (Note, this procedure was used to determine the solids content in each of resin dispersion examples described below). The Comparative Resin Dispersion A had a solids content of 38.79% by weight.

### Example 3: Preparation of Cationic, Amine-Functionalized, Polyepoxide-Based Resins Comprising Aliphatic Polyols (Experimental Resin Dispersions B and C)

A cationic, amine-functionalized, polyepoxide-based polymeric resins, suitable for use in formulating electrodepositable coating compositions, were prepared in the following manner. Components 1-5 listed in Table 3, below, were mixed in a flask set up for total reflux with stirring under nitrogen. The mixture was heated to a temperature of 130 °C and allowed to exothermn (175 °C maximum). A temperature of 145 °C was established in the reaction mixture and the reaction mixture was then held for 2 hours. Component 6 was introduced while allowing the mixture to cool to 125 °C followed by the addition of Components 7 and 8. Components 9 and 10 were then added to the reaction mixture quickly and the reaction mixture was allowed to exotherm. A temperature of 122 °C was established and the reaction mixture held for 1 hour, resulting in Resin Synthesis Products B and C, respectively.

TABLE 3

| | |
|---|---|
| Resin B | Resin C |

| | | |
|---|---|---|
| No. | Component | Parts-by-weight (grams) |

Resin Synthesis Stage

| | | | |
|---|---|---|---|
| 1 | Bisphenol A diglycidyl ether ¹ | 553.21 | 553.21 |
| 2 | Bisphenol A | 238.88 | 238.88 |
| 3 | Bisphenol A - ethylene oxide adduct | 214.74 | 214.74 |
| | (1/6 molar ratio BPA/EtO) | | |
| 4 | Methyl isobutyl ketone (MIBK) | 20.55 | 20.55 |
| 5 | Ethyl triphenyl phosphonium iodide | 0.54 | 0.54 |
| 6 | Vybar H-6164 ² | 10.26 | — |
| | Vybar H-6175 ² | — | 10.26 |
| 7 | Methyl isobutyl ketone | 74.89 | 74.89 |
| 8 | Crosslinker I ³ | 646.57 | 646.57 |
| 9 | Diethylene triamine - MIBK | 51.31 | 51.31 |
| | diketimine ⁴ | | |
| 10 | Methyl ethanol amine | 43.81 | 43.81 |

Resin Dispersion Stage

| | | | |
|---|---|---|---|
| 11 | Resin Synthesis Product B or C | 1669.28 | 1669.28 |
| 12 | Sulfamic acid | 36.47 | 36.47 |
| 13 | Deionized water | 1073.91 | 1073.91 |
| 14 | Gum rosin solution in butyl carbitol | 14.86 | 14.86 |
| | formal (30 wt %) | | |
| 15 | Deionized water | 1250.19 | 1250.19 |
| 16 | Deionized water | 1100.00 | 1100.00 |

¹ EPON 828, available from Hexion Corporation.
² Vybar H-6164/6175 are hydroxyl-functionalized branched polymerizates commercially available from Baker Hughes.
³ See Example 1, above.
⁴ 72.7% by weight (in MIBK) of the diketimine reaction product of 1 equivalent of diethylene triamine and 2 equivalents of MIBK.

A portion of the Resin Synthesis Product (B and C) (Component 11) was then poured into a pre-mixed solution of Components 12 and 13 to form a resin dispersion. Component 14 was then added quickly, and the resin dispersion was stirred for 1 hour. Component 15 was then introduced over 30 minutes to further dilute the resin dispersion, followed by the addition of Component 16. The free MIBK in the resin dispersion was removed from the dispersion under vacuum at a temperature of 60-70 °C.

The solids content of the resulting cationic, amine-functionalized, resin dispersion was determined as described above in Example 2. The Experimental Resin Dispersions B and C had a solids content of 38.79% and 40.8% by weight, respectively.

### Example 4: Preparation of a Cationic Resin Containing Jeffamine D400 (Cationic Resin D)

TABLE 4

| No. | Component | Parts-by-weight (grams) |
|---|---|---|
| 1 | DER 732¹ | 639.87 |
| 2 | Bisphenol A | 156.05 |
| 3 | Butyl Carbitol Formal | 7.96 |
| 4 | Benzyldimethyl Amine | 1.50 |
| 5 | Butyl Carbitol Formal | 3.12 |
| 6 | Butyl Carbitol Formal | 49.46 |
| 7 | JEFFAMINE D400 ² | 160.85 |
| 8 | Butyl Carbitol Formal | 7.96 |
| 9 | Bisphenol A diglycidyl ether ³ | 17.38 |
| 10 | Butyl Carbitol Formal | 6.20 |
| 11 | Lactic Acid | 54.92 |
| 12 | Deionized Water | 1225.50 |
| 13 | Rhodameen C5 ⁴ | 68.19 |
| 14 | Deionized water | 1132.45 |

¹Aliphatic epoxy resin available from Dow Chemical Co.
² A polypropylene oxide resin terminated with primary amines available from Huntsman Chemical
³ EPON 828, available from Hexion Corporation.
⁴ A surfactant available from Solvay

A cationic resin was prepared in the following manner from the materials included in Table 4: Materials 1-3 were added to a suitably equipped round bottom flask. The mixture is then heated to 130 °C. Materials 4-5 were then added. The reaction mixture was allowed to exotherm and held at 135 °C until the epoxy equivalent weight of 1230 was achieved. Epoxy equivalent weight (EEW) was measured by potentiometric titration using 0.1 N perchloric acid in acetic acid as the titrant. An aliquot (~1 g) was sampled from the reaction mixture and dissolved in a 1:2 w/w mixture of methylene chloride/acetic acid (~30 mL). Tetraethylammonium bromide (~1 g) was then added to the solution and fully dissolved. Epoxy equivalent weight was then evaluated using a pre-programmed potentiometer equipped with an automatic titrant dispenser unit, stir plate, and glass combination pH electrode, for example the Titrando series of titrators available from Metrohm. The 0.1 N perchloric acid titrant is added under constant pH monitoring until the pH of the sample rapidly decreases to a strongly acidic pH value and then stabilizes, indicating completion of the titration. EEW is calculated based on the determined endpoint, aliquot mass, and normality of the titrant solution. Component 6 was then introduced while cooling the content of the flask to 100 °C. Components 7-8 were added to the flask, the reaction mixture was allowed to exotherm and held at 90-95 °C until a stable Gardner-Holdt viscosity of G-K was attained (10 g of the reaction mixture in 8.7 g of 1-methoxy-2-propanol). The Gardner-Holdt viscosity was measured by filling a sample of the composition into a Gardern-Holdt tube (available from BYK-Gardner) leaving −1 cm of air and sealing with a stopper. The tube was then placed into a 23 °C water bath until the sample reaches that temperature. The sample was then placed into a holder with reference tubes (available from BYK-Gardner) and inverted. The viscosity is determined by the reference tube that the bubble rise speed matches. Components 9-10 were then introduced, and the reaction mixture held at 90-95 °C until a Gardner-Holdt viscosity of P was achieved. The content of the flask was solubilized into pre-blended Charges 11-12 and mixed for 30 min. Charge 13 was then introduced, and the resulting dispersion mixed for additional 30 minutes. At the end of the hold, component 14 was added slowly. The resulting Cationic Resin Dispersion D has a solids content of 33.36%.

### Example 5: Preparation of a Cationic Resin Intermediate (Cationic Resin Intermediate I)

TABLE 5

| # | Component | Parts-by-weight (grams) |
|---|---|---|
| 1 | Epon 828 | 8940.2 |
| 2 | Bisphenol A-ethylene oxide adduct¹ | 3242.1 |
| 3 | Bisphenol A | 2795.8 |
| 4 | Methyl isobutyl ketone | 781.8 |
| 5 | Tetronic 150R1² | 8.1 |
| 6 | Benzyldimethylamine | 12.4 |
| 7 | Benzyldimethylamine | 18.24 |
| 8 | Diketimine³ | 1623.6 |
| 9 | N-methylethanolamine | 758.7 |
| 10 | Sulfamic acid | 1524.4 |
| 11 | Deionized water | 12561 |
| 12 | Deionized water | 7170.3 |
| 13 | Deionized water | 11267.7 |
| 14 | Deionized water | 8450.7 |

¹A 6 mole ethoxylate of Bisphenol A
²Tetronic 150R1 is a nonionic surfactant available from BASF.
³Diketimine is the reaction product of diethylene triamine and Methyl isobutyl ketone at 72.3% solids in Methyl isobutyl ketone.

Cationic Resin Intermediate I was prepared in the following manner using components listed in Table 5. Materials 1-5 (Epon 828, bisphenol A-ethylene oxide adduct, bisphenol A, methyl isobutyl ketone, and Tetronic 150R1) were charged into a reaction vessel and heated under a nitrogen atmosphere to 125 °C. The first portion of the benzyldimethylamine, Material 6, was added and the reaction allowed to exotherm to around 180 °C. When the reaction reached 160 °C, a one-hour hold was started. After the peak exotherm the resin was allowed to cool back to 160 °C, continuing the hold. After the hold, the reaction was then cooled to 130 °C and the second portion of benzyldimethylamine, Material 7, was added. The reaction was held at 130 °C until an extrapolated epoxy equivalent weight of 1070. At the expected epoxy equivalent weight, Materials 8 and 9 (Diketimine and N-methylethanolamine) were added in succession and the mixture allowed to exotherm to around 150 °C. At the peak exotherm a one-hour hold was started while allowing the reaction to cool to 125 °C. After the one hour hold the resin was dispersed in an aqueous medium consisting of sulfamic acid and the first portion of deionized water. The dispersion was later reduced with the second, third, and fourth portions of deionized water. The resulting cationic soap was vacuum striped until the methyl isobutyl ketone content was less than 0.05%.

### Example 6: Preparation of a Cationic Resin Additive E

TABLE 6

| # | Component | Parts-by-weight (grams) |
|---|---|---|
| 1 | Cationic Resin Intermediate I (Example 5) | 50.10 |
| 2 | Propylene glycol mono propyl ether | 1.34 |
| 3 | Deionized Water | 1.47 |
| 4 | Epon 828 solution¹ | 781.8 |
| 5 | Ethylene Glycol mono butyl ether | 1.34 |
| 6 | Rhoadameen C5² | 1.98 |
| 7 | Deionized water | 0.93 |
| 8 | Deionized water | 4.00 |
| 9 | Deionized water | 14.97 |

¹85% Epon 828 (Epoxy resin available from Hexion Chemicals) + 15% Propylene glycol methyl ether.
²A surfactant available from Rhodia Chemicals

Cationic Resin Additive E was prepared in the following manner using components listed in Table 6. Material 1 was charged to the reactor and heated to 70 °C. Components 2 and 3 were introduced sequentially, followed by the addition of Material 4 over 15 min. Component 5 was added to the reaction mixture and held for 45 min. at 70 °C. The content of the flask was then heated to 88 °C and held for 3 hours. Two and ½ hours into the hold time, Components 6 and 7 were introduced. The heat source was removed from the reactor and Material 8 was introduced. At 32 °C, Charge 9 was added, and the mixture held for 1 hour resulting in the Cationic Resin Additive E.

### Preparation of Electrodepositable Coatings

TABLE 7

Paint

| No | Material | A | B | C |
|---|---|---|---|---|
| 1 | Resin A | 1278.4 | — | — |
| | Resin B | — | 1406.9 | — |
| | Resin C | — | — | 1337.6 |
| 2 | Resin D | 127.84 | 158.8 | 158.8 |
| 3 | Butyl Carbitol Formal¹ | 6.5 | 6.5 | 6.5 |
| 4 | Dowanol PM | 9.0 | 9.0 | 9.0 |
| 5 | Resin E | 144.4 | 144.4 | 144.4 |
| 6 | E6434ZCI² | 248.7 | 248.7 | 248.7 |
| 7 | DI Water | 1954.2 | 1825.7 | 1895.0 |

¹Available as MAZON 1651 from BASF
²Paste supplied from PPG Industries with a solid content of 52% and a pigment to binder weight ratio of 1.817 containing 1.6% dibutyltin oxide on total paste weight.

For each paint composition, Charges 1-5 were added sequentially into a plastic container at room temperature under agitation with 10 minutes of stirring after each addition. The mixture was stirred for at least 30 minutes at room temperature. Charges 6 and 7 were then added and the paint was allowed to stir until uniform, a minimum of 30 minutes. Charge 8 was added, and the paint was allowed to stir for a minimum of 30 minutes until uniform. The resulting cationic electrodepositable paint compositions had a solids content of 20.5%, determined as described previously, and a pigment to binder ratio of 0.12/1.0 by weight.

After 20% ultrafiltration (and reconstitution with deionized water), Coated panels were prepared from baths separately containing the cationic electrodepositable paint compositions and were evaluated for crater resistance. The results are reported below.

### Oil Spot Contamination Resistance Testing

The above-described electrodepositable paint compositions were then electrodeposited onto cold rolled steel test panels, 4×6×0.031 inches, pretreated with CHEMFOS C700/DI (CHEMFOS C700 is a zinc phosphate immersion pretreatment composition available from PPG Industries, Inc.). These panels are available from ACT Laboratories of Hillside, Mich. The panels were electrocoated in a manner well-known in the art by immersing them into a stirring bath at 32 °C and connecting the cathode of a direct current rectifier to the panel and connecting the rectifier's anode to stainless steel tubing used to circulate cooling water for bath temperature control. The voltage was increased from 0 to a set point voltage between 160V-190V over a period of 30 seconds and then held at that voltage for an additional 120 seconds. This combination of time, temperature and voltage provided a cured dry film thickness of 20 microns for all paints.

After electrodeposition, the panels were removed from the bath and rinsed vigorously with a spray of deionized water and cured by baking for 25 minutes at 177 °C in an electric oven.

The substrate panels comprising the electrodeposited coating layers were tested for oil spot contamination resistance, which evaluates the ability of an electrodeposited coating to resist crater formation upon cure. The electrodeposited coating layers were tested for oil spot crater resistance by localized contamination of the dried coating layers using three common oils: Ferrocote 6130 (Quaker Chemical Corporation, F), LubeCon Series O Lubricant (Castrol Industrial North America Inc., L) or Molub-Alloy Chain Oil 22 Spray (Castrol Industrial North America Inc., M). The oil was deposited as a droplet (<0.1 μL) onto the dried coating layers using a 40% by weight solution of the LubeCon Series O Lubricant in isopropanol, a 40% by weight solution of the or Molub-Alloy Chain Oil 22 Spray in isopropanol, or a 40% by weight solution of Ferrocote 6130 in isopropanol/butanol (75%/25% by weight) and a micropipette (Scilogex). The oil-spotted substrate panels were then cured as described above (baked for 20 minutes at 177 °C in an electric oven).

Each substrate panel was scanned using a Keyence VR-3200 optical measurement system to examine the depth of crater defects in the cured coating layer. The differences between the highest peak and lowest pit points of each of the resulting craters in each coating layer (crater depth, A) were averaged (at least 4 craters per coating layer) to quantify the results of the oil spot test. Lower values show improved performance. This test is referred to herein as the CRATER DEPTH TEST METHOD. The results show that both Vybar H-6164 and Vybar H-6175 show improved performance in the CRATER DEPTH TEST METHOD compared to the comparative example.

TABLE 8

| Coatings | | Oil Spot Resistance Crater Size (Δ, μm) | | |
|---|---|---|---|---|
| Composition | Additive | L | F | M |
| A | None | 17 | 20 | 17 |
| B | Vybar H-6164 | 9 | 15 | 8 |
| C | Vybar H-6175 | 12 | 17 | 12 |

### Alkyd Adhesion Testing

White alkyd adhesion testing evaluates the ability of a second cured coating layer to adhere to the underlying cured electrodeposited coating. White alkyd paint, C354-W404, available from PPG Industries, Inc., was reduced to a viscosity of 100 centipoise as measured at 20 rpm by a Brookfield DV-I Prime viscometer fitted with a cone and plate accessory at room temperature (23 °C). The reducing solvent was butyl acetate. E-coated test panels were prepared as described and baked in an electric oven at 155 °C, 175 °C, and 195 °C for 25 minutes. A wet white alkyd coating was applied to the cured e-coat using a #55 (0.055-inch diameter wire) wire-wound coating rod, available from R. D. Specialties. After allowing the white alkyd coating to flash for 10 minutes under ambient conditions, the panels were cured by baking horizontally for 30 minutes at 150 °C in an electric oven. After the panels had cooled to ambient temperature (about 25 °C), they were subjected to a crosshatch test.

The crosshatch test uses a scribing tool with teeth set 2 mm apart which cut the coating system down to metallic substrate. With two such perpendicular cuts, a “cross-hatch” results which is then tested with Scotch 898 tape. Failure constitutes loss of adhesion between the alkyd coating and the electrodeposited coating. Crosshatch adhesion results were tested on a scale of 0 to 10, with 0 being the worst and 10 being the best and are reported in the following table. A score of 0 indicates that the cured alkyd paint has been completely removed by the tape from within the scribed area. A score between 0 and 10 indicates that progressively less cured alkyd paint is removed by the tape from within the scribed area, paint being typically removed from the corners where two scribed lines intersect. A score of 10 indicates that there is no evidence of cured alkyd paint being removed by the tape from any of the corners where two scribed lines intersect. A rating of 9 or 10 is considered to be passing performance. As used herein, this test is referred to as the “WHITE ALKYD ADHESION TEST.” The results show that the comparative and experimental compositions performed similarly in the WHITE ALKYD AHEDION TEST while the experimental compositions still demonstrated improved performance in the crater control test above.

TABLE 9

| | |
|---|---|
| Coatings | White Alkyd Adhesion Test |

| Composition | Additive | 155 °C | 175 °C | 195 °C |
|---|---|---|---|---|
| A | None | 10 | 10 | 10 |
| B | Vybar H-6164 | 10 | 9 | 9 |
| C | Vybar H-6175 | 10 | 10 | 10 |

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
(a) a hydroxyl-functionalized branched polymerizate;
(b) an ionic salt group-containing film-forming polymer different from the hydroxyl-functionalized branched polymerizate; and
(c) a curing agent.

2. The electrodepositable coating composition of claim 1, wherein the hydroxyl-functionalized branched polymerizate comprises a branched polyalpha-olefin.

3. The electrodepositable coating composition of claim 2, wherein the branched polyalpha-olefin comprises constitutional units comprising the residue of:
(i) an alpha-olefin monomer having at least 6 carbon atoms; and
(ii) a hydroxyl-functional unsaturated monomer.

4. The electrodepositable coating composition of claim 3, wherein the branched polyalpha-olefin comprises a polymerization product comprising the residue of:
(i) an alpha-olefin monomer having at least 10 carbon atoms; and
(ii) a hydroxyl-functional unsaturated monomer.

5. The electrodepositable coating composition of claim 3, wherein the alpha-olefin monomer comprises an ethylenically unsaturated organic compound having at least six carbon atoms and a terminal carbon-carbon bond.

6. The electrodepositable coating composition of claim 5, wherein the ethylenically unsaturated organic compound has a structure H₂C═CH—R, wherein R is a hydrocarbon group having at least four carbon atoms.

7. The electrodepositable coating composition of claim 6, wherein R is an alkyl group.

8. (canceled)

9. The electrodepositable coating composition of claim 4, wherein the alpha-olefin monomer comprises 1-decene, 1-dodecene, 1-tetradecene, 1-hexadecene, 1-octadecene, 1-eicosene, or any combination thereof.

10. The electrodepositable coating composition of claim 3, wherein the hydroxyl-functional unsaturated monomer comprises an alpha, beta-unsaturated alcohol.

11. The electrodepositable coating composition of claim 3, wherein the hydroxyl-functional unsaturated monomer comprises allyl alcohol, 5-hexen-1-ol, 3-hexen-1-ol, 4-penten-1-ol, 3-penten-1-ol, 3-buten-1-ol, crotyl alcohol, elaidyl alcohol (9-trans-octadecen-1-ol), gadoleyl alcohol (9-cis-eicosen-1-ol), 9-decen-1-ol, 9-dodecen-1-ol, 10-undecylenyl alcohol, oleyl alcohol (9-cis-octadecen-1-ol), erucyl alcohol (13-cis-docosen-1-ol), brassidyl alcohol (13-trans-docosen-1-ol), ethoxylated and/or propoxylated derivatives thereof, acetic acid and formic acid esters of these alcohols, or any combination thereof.

12. The electrodepositable coating composition of claim 3, wherein the molar ratio of alpha-olefin monomer to the hydroxyl-functional unsaturated monomer is from 20:1 to 1:20.

13. The electrodepositable coating composition of claim 3, wherein the polymerization product is obtained by subjecting a mixture of the alpha-olefin monomer, the hydroxyl-functional unsaturated monomer, and at least one polymerization initiator to reaction conditions sufficient to copolymerize the alpha-olefin monomer and the hydroxyl-functional unsaturated monomer.

14. The electrodepositable coating composition of claim 13, wherein the polymerization initiator comprises a free radical initiator comprising an organic peroxide.

15. The electrodepositable coating composition of claim 1, wherein the hydroxyl-functionalized branched polymerizate has a hydroxyl equivalent weight of 50 to 3,000 g/eq.

16-17. (canceled)

18. The electrodepositable coating composition of claim 1, wherein the ionic salt group-containing film-forming polymer comprises a cationic salt group-containing film-forming polymer.

19. The electrodepositable coating composition of claim 1, wherein the ionic salt group-containing film-forming polymer comprises an anionic salt group-containing film-forming polymer.

20. (canceled)

21. The electrodepositable coating composition of claim 1, wherein the curing agent comprises a polyisocyanate curing agent and the hydroxyl-functionalized branched polymerizate comprises a blocking agent for the polyisocyanate curing agent.

22. An electrodepositable coating composition comprising:
(a) a reaction product of a hydroxyl-functionalized branched polymerizate and a polyisocyanate;
(b) an ionic salt group-containing film-forming polymer different from the hydroxyl-functionalized branched polymerizate; and
(c) optionally a curing agent (1) different from the polyisocyanate and/or (2) a polyisocyanate that does not include the hydroxyl-functional branched polymerizate as a blocking agent.

23-27. (canceled)

28. A method of coating a substrate comprising electrophoretically applying the electrodepositable coating composition of claim 1 to at least a portion of the substrate.

29. A coated substrate having a coating comprising:
(a) a hydroxyl-functionalized branched polymerizate;
(b) an ionic salt group-containing film-forming polymer different from the hydroxyl-functionalized branched polymerizate; and
(c) a curing agent.

30-33. (canceled)
